(19) United States
(12) Patent Application Publication
(10) Pub. No.: US 2006/0233225 A1
(43) Pub. Date: Oct. 19, 2006

(54) Frequency synchronization apparatus and frequency synchronization method

(76) Inventor: Yukihiro Omoto, 6F YODOGAWA 5-BANKAN 2-1 TOYOSAKI (JP)

Correspondence Address: SNELL & WILMER L.L.P., 600 ANTON BOULEVARD, SUITE 1400, COSTA MESA, CA, 92626, US

(21) Appl. No.: 10/550,669

(22) PCT Filed: Mar. 30, 2004
(86) PCT No.: PCT/JP04/04495

§ 371 Date: Sep. 26, 2005

(30) Foreign Application Priority Data
Mar. 31, 2003 (JP) 2003-094926

(51) Int. Cl. H04B 1/00

(52) U.S. Cl. 375/149

(57) ABSTRACT

A first frequency synchronization unit (103) corresponds to the frequency synchronization apparatus of the present invention. A higher apparatus that is, for example, a wireless receiver supplies a reception signal to the first frequency synchronization unit (103) via an A/D converter (101) and an orthogonal detector (102). A synchronization symbol that includes a predetermined waveform at least twice is incorporated into the reception signal. A correlation estimator (104) generates a reference signal expressing the same waveform as the synchronization symbol, and successively finds correlation vectors between the reception signal and the reference signal. A first signal error detector (106) finds a frequency error based on an average phase difference of predetermined correlation vectors, and finds an absolute phase error based on transition of absolute phase of predetermined correlation vectors. A first frequency corrector (108) simultaneously gives the reception signal a frequency shift and phase rotation that cancel the errors.

### TECHNICAL FIELD

The present invention relates to a frequency synchronization apparatus and a frequency synchronization method, and in particular to a technique for simultaneously correcting shift in frequency and absolute phase in a reception signal, based on a single synchronization symbol.

### BACKGROUND ART

In recent years numerous transmission methods have been developed for use in mobile communication, digital CATV (cable television) systems, and the like. In order for transmission to be performed correctly, it is necessary for a reception apparatus to establish synchronization between the frequency of a reception signal and an internal reception reference signal. This is because the reception apparatus will be unable to obtain the original transmission data correctly if it demodulates the reception signal without having established synchronization.

Frequency synchronization is generally performed using synchronization symbols that are transmitted incorporated in a signal. On receiving the signal, the reception apparatus detects an frequency error between the received signal and an internal reference signal expressing the same waveform as the synchronization symbol, based on a correlation between the signals, and corrects the reception signal according to the result of the detection.

Conventional reception apparatuses that perform frequency synchronization using synchronization symbols are commonly known.

As one example, Japanese Laid Open Patent Application No. 2001-136149 discloses an OFDM (Orthogonal Frequency Division Multiplexing) reception apparatus that extracts a short preamble, which is a synchronization symbol, from a reception signal, and corrects the carrier frequency of a receiver based on the extracted short preamble.

As a further example, Japanese Laid Open Patent Application No. 2002-511710 discloses a frequency coarse synchronization method of correcting the carrier frequency based on a cross correlation between an envelope obtained by demodulating a reception signal and a reference signal when the synchronization signal is expressed by a signal amplitude envelope, and correcting the carrier frequency based on an autocorrelation of the envelope when a waveform identical to the envelop occurs twice.

However, although they correct the frequency error of the reception signal, the conventional apparatus and method do not correct the absolute phase of the reception signal. This gives rise to a problem of an undesirable result being obtained by an apparatus at a latter stage when the latter-stage apparatus uses absolute phase as a reference to process the signal obtained by the conventional apparatus and method.

For example, if the latter-stage apparatus is a demodulator that demodulates the signal with-reference to absolute phase, an increased BER (bit error rate) occurs because the demodulator is unable to demodulate the signal correctly.

Furthermore, when synchronizing in two stages, i.e., coarse synchronization according to the conventional apparatus and method and fine synchronization according to the latter-stage apparatus and method, if the latter-stage apparatus is a synchronizer that has a function of correcting the absolute phase error, the time required by the latter-stage apparatus to correct the absolute phase error increases as the absolute phase error increases.

Note that other related techniques included that in IEEE Standard 802.11a-1999, High Speed Physical Layer in the 5 GHz Band”, pages 12-13, which relates to OFDM wireless communication, and stipulates the two types of synchronization signals: STS (short training symbols) which are for frequency synchronization, and LTS (long training symbols) which are for absolute phase synchronization.

A reception apparatus that conforms to this standard performs a Fourier conversion of a time domain reception signal whose frequency has been corrected using STS, and further performs absolute phase correction of a frequency domain signal of each sub-carrier using LTS.

This related technique realizes highly accurate absolute phase correction of each sub-carrier, but is limited to being applied to OFDM, and gives rise to a problem that the actual transmission efficiency is reduced because it is necessary to transmit two types of synchronization symbols.

### DISCLOSURE OF THE INVENTION

In order to solve the stated problems, the object of the present invention is to provide a frequency synchronization apparatus and a frequency synchronization method that can be applied without depending on the modulation method, and that are able to simultaneously correct frequency error and absolute phase error in a reception signal using a single synchronization symbol.

The frequency synchronization apparatus of the present invention estimates a frequency error between an input signal from an external source and a reference signal, based on a correlation therebetween, and corrects the input signal so as to cancel out the frequency error, the input signal including a synchronization symbol that is composed of a synchronization waveform that exhibits a predetermined autocorrelation property and is included at least twice in the synchronization symbol, and the reference signal expressing a waveform that is identical to the synchronization waveform, the frequency synchronization apparatus including: a correlation unit operable to successively find correlation vectors between the input signal and the reference signal; a timing detection unit operable to generate, based on chronological transition in magnitude of the obtained correlation vectors, a synchronization waveform timing signal that indicates a predetermined timing in each cycle of the synchronization waveform; a first frequency error detection unit operable to find a frequency error between the input signal and the reference signal, based on an average phase difference between each pair of chronologically neighboring correlation vectors, each of which is obtained with the timing indicated by the synchronization waveform timing signal; an absolute phase error detection unit operable to find an absolute phase error between the input signal and the reference signal, based on chronological transition of absolute phase of correlation vectors found with the timing indicated by the synchronization waveform timing signal; and a first frequency correction unit operable to correct the input signal by simultaneously giving the input signal a frequency shift and a phase rotation that cancel out the found frequency error and the found absolute phase error.

The frequency synchronization circuit of the present invention estimates a frequency error between an input signal from an external source and a reference signal, based on a correlation therebetween, and corrects the input signal so as to cancel out the frequency error, the input signal including a synchronization symbol that is composed of a synchronization waveform that exhibits a predetermined autocorrelation property and is included at least twice in the synchronization symbol, and the reference signal expressing a waveform that is identical to the synchronization waveform, the frequency synchronization circuit including: a correlation circuit operable to successively find correlation vectors between the input signal and the reference signal; a timing detection circuit operable to generate, based on chronological transition in magnitude of the obtained correlation vectors, a synchronization waveform timing signal that indicates a predetermined timing in each cycle of the synchronization waveform; a first frequency error detection circuit operable to find a frequency error between the input signal and the reference signal, based on an average phase difference between each pair of chronologically neighboring correlation vectors, each of which is obtained with the timing indicated by the synchronization waveform timing signal; an absolute phase error detection circuit operable to find an absolute phase error between the input signal and the reference signal, based on chronological transition of absolute phase of correlation vectors found with the timing indicated by the synchronization waveform timing signal; and a first frequency correction circuit operable to correct the input signal by simultaneously giving the input signal a frequency shift and a phase rotation that cancel out the found frequency error and the found absolute phase error.

The one-chip integrated circuit estimates a frequency error between an input signal from an external source and a reference signal, based on a correlation therebetween, and corrects the input signal so as to cancel out the frequency error, the input signal including a synchronization symbol that is composed of a synchronization waveform that exhibits a predetermined autocorrelation property and is included at least twice in the synchronization symbol, and the reference signal expressing a waveform that is identical to the synchronization waveform, the one-chip integrated circuit including: in input terminal operable to obtain the input signal; a correlation circuit operable to successively find correlation vectors between the input signal and the reference signal; a timing detection circuit operable to generate, based on chronological transition in magnitude of the obtained correlation vectors, a synchronization waveform timing signal that indicates a predetermined timing in each cycle of the synchronization waveform; a first frequency error detection circuit operable to find a frequency error between the input signal and the reference signal, based on an average phase difference between each pair of chronologically neighboring correlation vectors, each of which is obtained with the timing indicated by the synchronization waveform timing signal; an absolute phase error detection circuit operable to find an absolute phase error between the input signal and the reference signal, based on chronological transition of absolute phase of correlation vectors found with the timing indicated by the synchronization waveform timing signal; a first frequency correction circuit operable to correct the input signal by simultaneously giving the input signal a frequency shift and a phase rotation that cancel out the found frequency error and the found absolute phase error; and an output terminal operable to output the corrected input signal.

According to the stated structures, the frequency synchronization apparatus, the frequency synchronization circuit, and the one-chip IC for frequency synchronization are able to simultaneously correct frequency error and absolute phase error in an input signal that includes the synchronization symbol, based on the synchronization symbol.

The synchronization symbol is a single signal that is composed of a signal waveform that exhibits the aforementioned autocorrelation property and occurs at least twice, and therefore loss in efficiency of transmitting the synchronization signal is low. Furthermore, since the processing performed by the compositional elements that relate to signal correction is all operations in a time series, complicated processing such as Fourier transformation is unnecessary, and the apparatus can be realized with a relatively simple overall structure. Furthermore, the stated structures can be applied without dependence on the modulation method.

Furthermore, the frequency synchronization apparatus may further include: a frequency error holding unit operable to hold the found frequency error, and, when a new frequency error is subsequently found, update the held frequency error with the new frequency error depending on a difference between the held frequency error and the new frequency error; and an absolute phase error holding unit operable to hold the found absolute phase error, and, when a new absolute phase error is subsequently found, update the held absolute phase error with the new absolute phase error depending on a difference between the held absolute phase error and the new absolute phase error, wherein the first frequency correction unit corrects the input signal by simultaneously giving the input signal a frequency shift and a phase rotation that cancel out the frequency error being held by the frequency error holding unit and the absolute phase error being held by the absolute phase error holding unit.

According to the stated structure, when there is not a great fluctuation in the frequency error or when there is not a great fluctuation in the absolute phase error, the frequency error or absolute phase error are maintained without updating, and the input signal is corrected based the maintained frequency error and absolute phase error. Therefore, the correction amount fluctuates relatively infrequently. For example, if an apparatus that follows the correction amount fluctuation of the frequency synchronization apparatus exists at latter stage than the frequency synchronization apparatus, the load on the latter-stage apparatus to follow the correction amount fluctuation is light.

Furthermore, the frequency synchronization apparatus may further include a second frequency correction unit operable to be supplied with a control signal, and give an output signal from the first frequency correction unit a frequency shift corresponding to the control signal; an absolute phase error detection unit operable to demodulate an output signal from the second frequency correction unit and successively find symbol points in the demodulated output signal, and detect a phase error between the found symbol points and symbol points able to be found in a modulation method of the output signal; and a second frequency error detection unit operable to successively output to the second frequency correction unit a control signal for giving an output signal from the first frequency correction unit a frequency shift that cancels out the detected phase error.

According to the stated structure, after the first frequency correction unit corrects the frequency error and absolute phase error of the input signal based on the synchronization symbol, the second frequency correction unit then corrects the frequency error of the input signal during the data symbol period, based on shift of the symbol points. Therefore, frequency fluctuations that occur in the data symbol period can also be finely corrected, and highly reliable communication can be realized.

Furthermore, in the frequency synchronization apparatus, the input signal may have been modulated according to a multicarrier modulation method, the phase error detection unit may demodulate an output signal from the second frequency correction unit and, for each sub-carrier in the demodulated output signal, successively find symbol points in the sub-carrier and detects phase error between the found symbol points and symbol points able to be obtained in a modulation method of the sub-carrier, the frequency synchronization apparatus may further include: a phase error averaging unit operable to average phase errors detected simultaneously for all or some of the sub-carriers, and the second frequency detection unit may successively output to the second frequency correction unit a control signal for giving an output signal from the first frequency correction unit a frequency shift that cancels out the average phase error.

The stated structure is particularly ideal for continuing to correct the frequency error of an input signal modulated according to a multicarrier modulation method in the data symbol period. Specifically, if tone noise is present in a specific sub-carrier, the effect of the noise is dispersed over all or some sub-carriers by averaging the phase error of all or some of the sub-carriers. This reduces the danger of mistakenly correcting all or some of the sub-carriers with information of the specific sub-carrier in which the noise is present.

Furthermore, in the frequency synchronization apparatus, the input signal may include a data symbol in addition to the synchronization symbol, and a band of the synchronization symbol may be limited so as to fall within an occupied frequency band of the data symbol.

The stated structure ensures that the synchronization symbol will not effect a channel of a neighboring frequency.

Furthermore, in the frequency synchronization apparatus, the synchronization symbol may be characterized in that the synchronization waveform is included at least twice with a predetermined time interval therebetween.

Elimination of the high frequency component causes distortions at either end, in terms of time, of a synchronization waveform whose band has been limited. However, according to the stated structure, the synchronization waveform is repeated such that the distorted parts do no overlap. Therefore, the autocorrelation property of the synchronization symbol is maintained as much as possible.

The frequency synchronization method of the present invention estimates a frequency error between an input signal from an external source and a reference signal, based on a correlation therebetween, and corrects the input signal so as to cancel out the frequency error, the input signal including a synchronization symbol that is composed of a synchronization waveform that exhibits a predetermined autocorrelation property and is included at least twice in the synchronization symbol, and the reference signal expressing a waveform that is identical to the synchronization waveform, the frequency synchronization method including: a correlation step of successively finding correlation vectors between the input signal and the reference signal; a timing detection step of identifying, based on chronological transition in magnitude of the obtained correlation vectors, each cycle of the synchronization waveform; a first frequency error detection step of finding a frequency error between the input signal and the reference signal, based on an average phase difference between each pair of chronologically neighboring correlation vectors that are representative of the identified cycles; an absolute phase error detection step of finding an absolute phase error between the input signal and the reference signal, based on chronological transition of absolute phase of correlation vectors that are representative of the identified cycles; and a first frequency correction step of correcting the input signal by simultaneously giving the input signal a frequency shift and a phase rotation that cancel out the found frequency error and the found absolute phase error.

The frequency synchronization method may further include: a frequency error recording step of recording the found frequency error, and, when a new frequency error is subsequently found, updating the recorded frequency error with the new frequency error depending on a difference between the recorded frequency error and the new frequency error; and an absolute phase error recording step of recording the found absolute phase error, and, when a new absolute phase error is subsequently found, updating the recorded absolute phase error with the new absolute phase error depending on a difference between the recorded absolute phase error and the new absolute phase error, wherein the first frequency correction step corrects the input signal by simultaneously giving the input signal a frequency shift and a phase rotation that cancel out the frequency error recorded in the frequency error holding step and the absolute phase error recorded in the absolute phase error recording step.

The frequency synchronization method may further include: a second frequency correction step of being instructed of a frequency shift, and giving a signal obtained in the first frequency correction step the instructed frequency shift; an absolute phase error detection step of demodulating a signal obtained in the second frequency correction step and successively finding symbol points in the demodulated output signal, and detecting a phase error between the found symbol points and symbol points able to be found in a modulation method of the output signal; and a second frequency error detection step of successively instructing to the second frequency correction step of a frequency shift that cancels out the detected phase error.

Here, the input signal may have been modulated according to a multicarrier modulation method, the phase error detection step may demodulate a signal obtained in the second frequency correction step and, for each sub-carrier in the demodulated output signal, successively finds symbol points in the sub-carrier and detects phase error between the found symbol points and symbol points able to be obtained in a modulation method of the sub-carrier, the frequency synchronization method may further include: a phase error averaging step of averaging phase errors detected simultaneously for all or some of the sub-carriers in the absolute phase error detection step, and the second frequency detection step may successively instruct the second frequency correction step of a frequency shift that cancels out the average phase error.

According to these methods, frequency synchronization can be executed with the aforementioned effects.

The synchronization symbol generation method of the present intention includes: a selection step of selecting a numeric sequence that expresses a digital signal and that has a predetermined autocorrelation property; a synchronization waveform generation step of generating a synchronization waveform by eliminating a high frequency component that is outside a desired and from the digital signal expressed by the numeric sequence whose sampling frequency is treated so as to be half or less of the desired band width; and a synchronization symbol generation step of generating a synchronization symbol so as to include the synchronization waveform at least twice.

Here, in the synchronization symbol generation step, the synchronization symbol may be generated such that a predetermined time interval is placed between each synchronization waveform.

According to the stated methods, a synchronization symbol is obtained by repeating a synchronization waveform that has a high autocorrelation property and that is of a frequency range that falls within a desired band. Therefore, a synchronization symbol can be obtained that does not affect channels of neighboring frequencies, and that is suitable for the aforementioned frequency synchronization apparatus and frequency synchronization method.

In addition, if the synchronization waveform is repeated with a predetermined interval therebetween, the autocorrelation property of the synchronization symbol is maintained as much as possible for the aforementioned reasons.

The signal transmission method of the present invention is for transmitting a signal that includes a predetermined synchronization symbol and correcting a received signal using a synchronization symbol included in the received signal, including: a selection step of selecting a numeric sequence that expresses a digital signal and that has a predetermined autocorrelation property; a synchronization waveform generation step of generating a synchronization waveform by eliminating a high frequency component that is outside a desired band from the digital signal expressed by the numeric sequence whose sampling frequency is treated so as to be being half or less of the desired band width; a synchronization symbol generation step of generating a synchronization symbol so as to include the synchronization waveform at least twice; a transmission step of transmitting a signal that includes the generated synchronization symbol; a reception step of receiving the transmitted signal; and a synchronization step of estimating a frequency error between the received signal and a reference signal that expresses the synchronization waveform, based on a correlation between the received signal and the reference signal, and correcting the received signal so as to cancel out the frequency error.

Here, in the synchronization symbol generation step, the synchronization symbol may be generated such that a predetermined time interval is placed between each synchronization waveform.

Here, the synchronization step may include: a correlation sub-step of successively finding correlation vectors between the received signal and the reference signal; a timing detection sub-step of identifying each cycle of a synchronization waveform included in the received signal, based on a chronological transition in magnitude of the found correlation vectors; a first frequency error detection sub-step of finding a frequency error between the received signal and the reference signal, based on an average phase difference of chronologically neighboring pairs of correlation vectors that are representative of each identified cycle; and a first frequency correction sub-step of correcting the received signal by giving the received signal a frequency shift that cancels out the found frequency error.

Here, the synchronization step may further include: an absolute phase error detection sub-step of finding an absolute phase error between the received signal and the reference signal, based on chronological transition of absolute phase of the correlation vectors that are representative of each identified cycle, and in the first frequency correction sub-step, the received signal may be corrected by simultaneously giving the received signal a frequency shift and phase rotation that cancel out the found frequency error and the found absolute phase error.

According to the stated methods, a synchronization symbol having the aforementioned advantages can be obtained, and frequency synchronization having the aforementioned effects can be executed.

### BRIEF DESCRIPTION OF THE DRAWINGS

FIG. 1 is a functional block diagram showing the overall structure of a frequency synchronization apparatus of the first embodiment;

FIG. 2 shows the configuration of a transmission frame;

FIG. 3 is a conceptual drawing for describing processing for detecting frequency error and absolute phase error;

FIG. 4 is a functional block diagram showing the detailed structure of a correlation estimator;

FIG. 5 is a functional block diagram showing the detailed structure of a timing detector;

FIG. 6 is a functional block diagram showing the detailed structure of a first frequency error detector;

FIG. 7 is a functional block diagram showing the detailed structure of an absolute phase error detector;

FIG. 8 is a functional block diagram showing the detailed structure of a first frequency corrector;

FIG. 9 is a graph showing chronological transition (convergence speed) of absolute phase error;

FIG. 10 is a functional block diagram showing the overall structure of a frequency synchronization apparatus of the second embodiment;

FIG. 11 is a functional block diagram showing the overall structure of a frequency synchronization apparatus of the third embodiment;

FIG. 12 is a graph showing chronological transition (convergence speed) of absolute phase error;

FIG. 13 is a functional block diagram showing an example of a modification of a second frequency synchronizer;

FIG. 14 shows the detailed configuration of a synchronization waveform;

FIG. 15 is a graph showing autocorrelation property of a synchronization waveform;

FIG. 16 is a graph showing the spectrum of the synchronization waveform; and

FIG. 17 is a time chart showing chronological arrangement of synchronization waveforms that compose a synchronization symbol.

### BEST MODE FOR CARRYING OUT THE INVENTION

The frequency synchronization apparatus of the present invention synchronizes frequency and absolute phase of an input signal that is supplied by a higher apparatus and that includes a synchronization symbol in which a synchronization waveform that exhibits a strong autocorrelation property occurs at least twice. Here, the frequency synchronization apparatus synchronizes the input signal with an internal reference signal that expresses a waveform that is the same as the synchronization waveform. The frequency synchronization apparatus then outputs the synchronized input signal to the higher apparatus.

For simplicity, the higher apparatus is described as being a wireless reception apparatus, for example, and the frequency synchronization apparatus is supplied with a reception signal (a reception signal in a broad sense including orthogonal component signals included in the reception signal) from the wireless reception apparatus, and synchronizes the frequency and absolute phase of the reception signal with the reference signal.

### First Embodiment

The following describes a frequency synchronization apparatus of a first embodiment with reference to the drawings.

<Overall Structure>

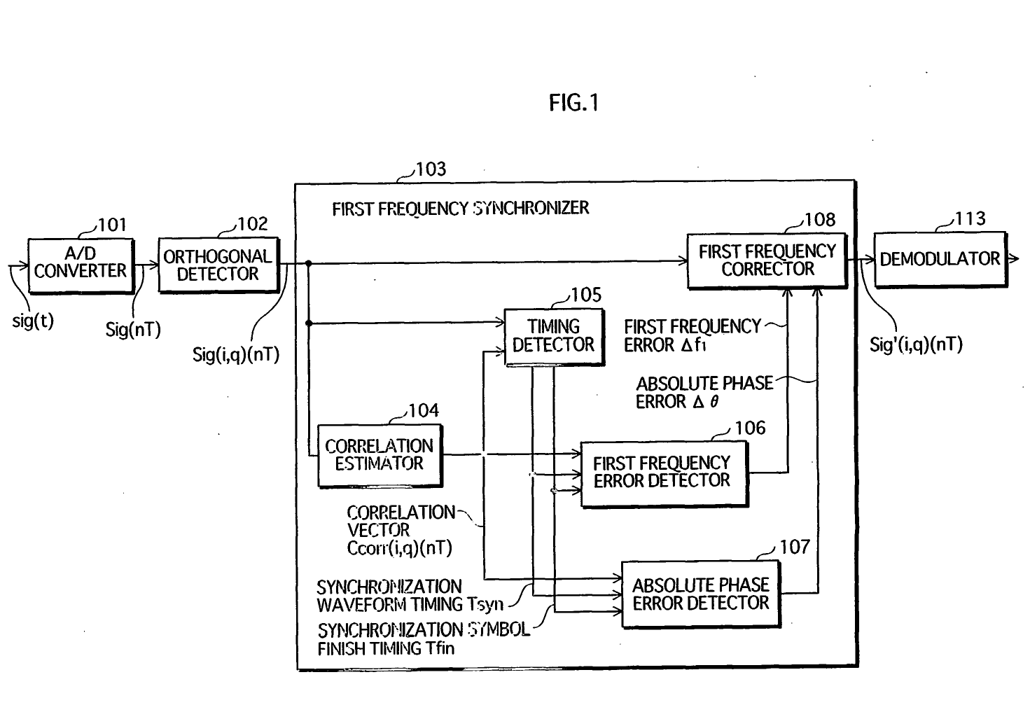

FIG. 1 is a functional block diagram showing the overall structure of the frequency synchronization apparatus of the first embodiment, together with part of the wireless reception apparatus that is the higher apparatus. In FIG. 1, a first frequency synchronizer 103 corresponds to the frequency synchronization apparatus, and an A/D (analog/digital) converter 101, an orthogonal detector 102, and a demodulator 113 correspond to part of the wireless reception apparatus.

The reception signal is converted to a signal sig(t) of an intermediate frequency selected appropriately by a tuner (not illustrated) in the wireless reception apparatus. The A/D converter 101 converts the signal sig(t) to a time series digital signal Sig(nT), and the orthogonal detector 102 obtains a baseband orthogonal component signal Sig(i,q)(nT) by performing orthogonal detection of the digital signal Sig(nT). Hereinafter, the orthogonal component signal Sig(i,q)(nT) is simply referred to as a reception signal, depending on the context.

The first frequency detector 103 is supplied with the reception signal Sig(i,q)(nT), synchronizes the frequency and absolute phase thereof with a reference signal generated by a correlation estimator 104, and outputs the synchronized signal Sig′(i,q)(nT) to the demodulator 113.

The demodulator 113 restores the original transmitted data by demodulating the signal Sig′(i,q)(nT).

The first frequency synchronizer 103 may be realized by, for example, a DSP (digital signal processor) and a ROM (read only memory) and the like, and may achieve its functions by the DSP executing a program recorded in the ROM. In such a case, the blocks in the first frequency synchronizer 103 correspond to program modules for realizing the functions of the first frequency synchronizer 103.

Alternatively, the first frequency synchronizer 103 may be realized by, for example, digital circuits that correspond to the functions of the blocks, or may be realized by a one-chip IC (integrated circuit) in which the circuits are formed. Such a one-chip IC includes an input terminal for obtaining a signal supplied from an external source, and an output terminal for outputting a signal whose frequency has been synchronized to an external source.

<Reception Signal>

The wireless reception apparatus receives a signal that is expressed by chronologically repeating transmission frames that are the unit by which the signal is transmitted.

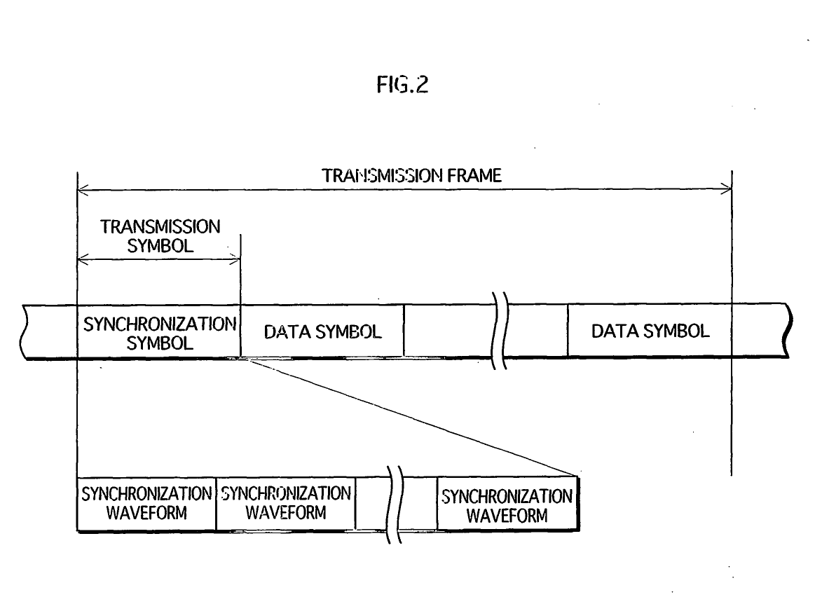

FIG. 2 is a format diagram showing the configuration of a transmission frame. The transmission frame is composed of a plurality of transmission symbols, the top transmission symbol being a synchronization symbol used for frequency synchronization, and data symbols that express actual information follow the synchronization symbol.

The synchronization symbol is a signal in which a synchronization waveform (for example, a chirp signal, a PN (pseudorandom noise) sequence or the like) exhibiting a strong autocorrelation property occurs at least twice. The synchronization symbol may be incorporated at predetermined intervals through the transmission frame instead of being at the top of the transmission frame. A signal in which each transmission frame includes a plurality of synchronization symbols can be received more accurately because frequency synchronization can be re-established each time the synchronization symbol is detected.

The method used for generating the synchronization waveform and the synchronization symbol is described in detail later.

<First Frequency Synchronizer 103>

Returning to FIG. 1, the first frequency synchronizer 103 has a correlation estimator 104, a timing detector 105, a first frequency error detector 106, an absolute phase error detector 107 and a first frequency corrector 108.

The correlation estimator 104 generates a reference signal that expresses a waveform that is the same as that in the synchronization symbol, and calculates a time series of correlation vectors Ccorr(i,q)(nT) of the reception signal Sig(i,q) (nT) and the reference signal. The timing detector 105 outputs a synchronization waveform timing signal Tsyn and a synchronization symbol finish timing signal Tfin. The synchronization waveform timing signal Tsyn indicates when the magnitude of the correlation vector exceeds a predetermined threshold (hereinafter, this is called “peak timing”) in each cycle of the synchronization waveform in the reception signal, based on the correlation vector time transition. The synchronization symbol finish timing signal Tfin indicates when the synchronization symbol finishes. The first frequency error detector 106 estimates a frequency error [symbol] f1 at the synchronization symbol finishing timing of the reception signal and the reference signal, based on an average phase difference between each chronologically adjacent pair of correlation vectors obtained at each peak timing. The absolute phase error detector 107 finds an absolute phase error [symbol] θ at the synchronization symbol finish timing of the reception signal and the reference signal, based on the chronological transition of the absolute phase of the correlation vector obtained at each peak timing. The first frequency corrector 108 obtains a corrected reception signal sig′(i,q)(nT) by simultaneously giving the reception signal a frequency shift and a phase rotation that cancel out the obtained frequency error [symbol] f1 and absolute phase error [symbol] θ. The first frequency corrector 108 then outputs the corrected reception signal sig′(i,q) (nT) to the demodulator 113.

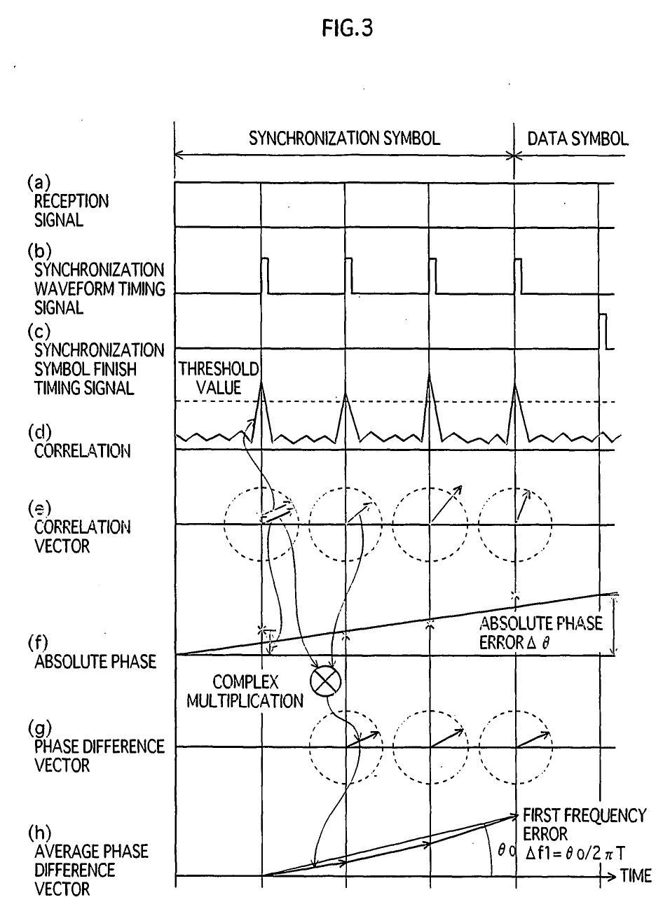

FIG. 3 is a conceptual drawing for describing the above signal processing, and shows principal signal contents schematically. The following describes details of the structure of each component of the first frequency synchronizer 103 and the signal processing performed by the components.

<Correlation Estimator 104>

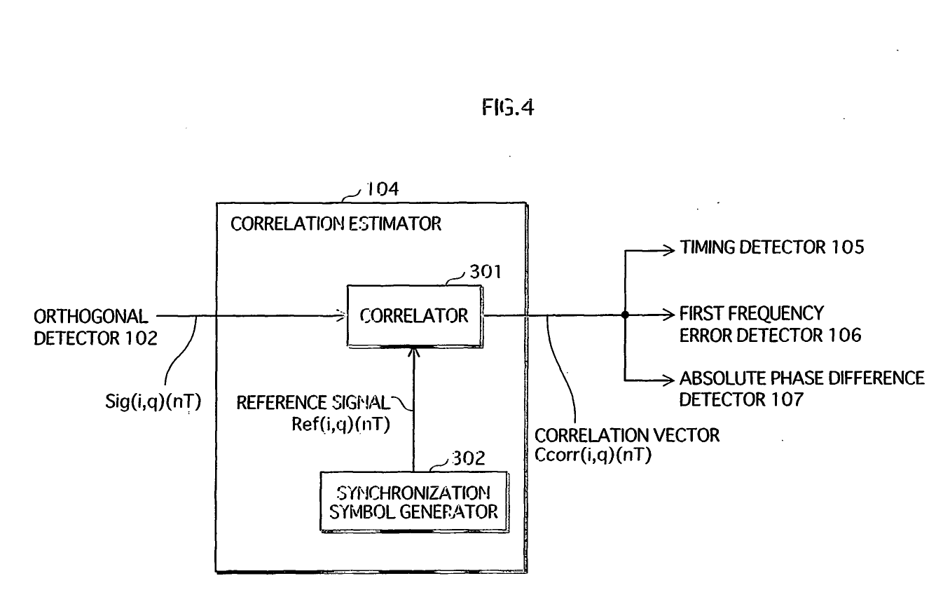

FIG. 4 is a functional block diagram showing the detailed structure of the correlation estimator 104. The correlation estimator 104 has a correlator 301 and a synchronization symbol generator 302.

The symbol generator 302 generates a reference signal Ref(i,q) (nT) that expresses a waveform the same as that in the synchronization symbol. The synchronization symbol generator 302 is realized with use of a memory circuit, for example. Specifically, the synchronization symbol generator 302 may hold, in advance, time series sampling values indicating the synchronization waveform, in a memory circuit (not illustrated), and generate the synchronization symbol by repeatedly reading the sampling values.

The correlator 301 calculates correlation vectors Ccorr(i,q)(nT) between the reception signal Sig(i,q)(nT) and the reference signal Ref(i,q)(nT) (FIG. 3(e)). These are calculated according to Equation 1.

$${Ccorr}_{( i , q )} ( nT ) = {\sum }_{k}^{L} \{ {Sig}_{( i , q )} ( ( n - k ) T ) \cdot {Ref}_{( i , q )} ( k ) \} \qquad ( 1 )$$

L: sample count of one cycle of synchronization waveform in reference signal

<Timing Detector 105>

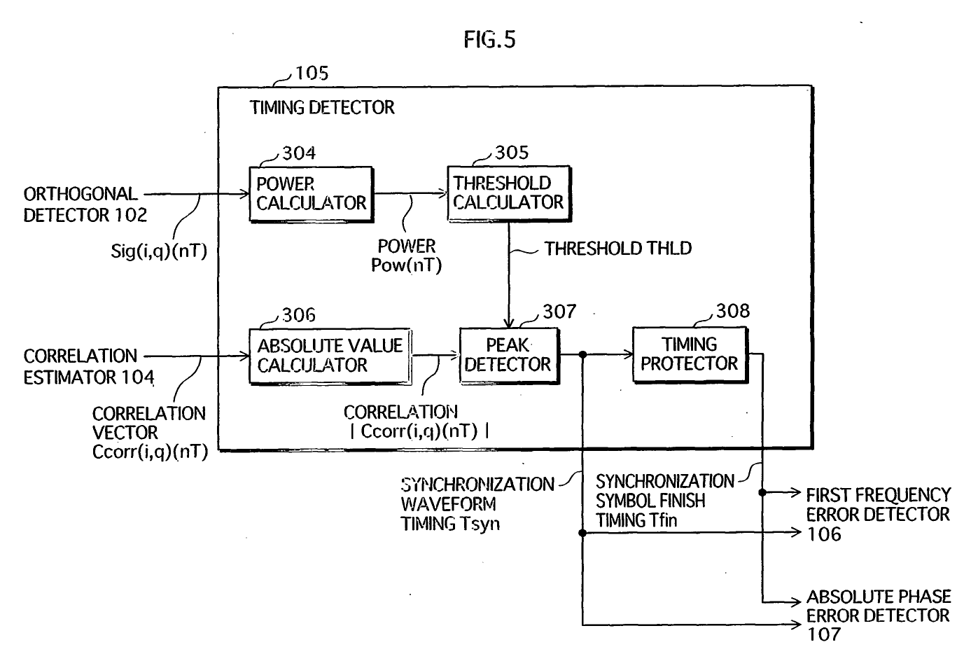

FIG. 5 is a functional block drawing showing the detailed structure of the timing detector 105. The timing detector 105 has a power calculator 304, a threshold calculator 305, an absolute value calculator 306, a peak detector 307, and a timing protector 308.

The absolute value calculator 306 finds a correlation |Ccorr(i,q)(nT)| of the correlation vectors Ccorr(i,q)(nT) (FIG. 3(d)). This correlation can be found as, for example, the square of the i,q component, the absolute value of correlation vectors, or the absolute value total of the i,q component.

The peak detector 307 outputs a synchronization waveform timing signal Tsyn that indicates timing when the correlation |Ccorr(i,q)(nT)| exceeds a threshold value THLD that is used as a reference for judgment (FIG. 3(b)).

Since a waveform exhibiting a strong autocorrelation property is used, the correlation peak appears once in each cycle of the synchronization waveform in the reception signal. In other words, the cycles of the synchronization waveform in the reception signal can be identified by the peaks.

The threshold value THLD is set by the threshold value calculator 305 according to the signal power Pow(nT) of the reception signal Sig(i,q)(nT) calculated by the power calculator 304. The threshold calculator 305 setting the threshold value according to the power of the reception signal enables the peak detector 307 to detect the peak appropriately by tracking fluctuation in transmission path properties. The threshold calculator 305 may set the threshold value according to an average transition of the signal power over a predetermined period of time.

When a peak timing has been shown by the synchronization waveform timing signal Tsyn and a new peak timing is not shown for a subsequent predetermined period of time (for example, a sample count L of one cycle of the synchronization waveform in the reference signal), the timing protector 308 outputs a synchronization symbol finish timing signal Tfin indicating that the synchronization symbol has finished (FIG. 3(c)).

<First Frequency Error Detector 106>

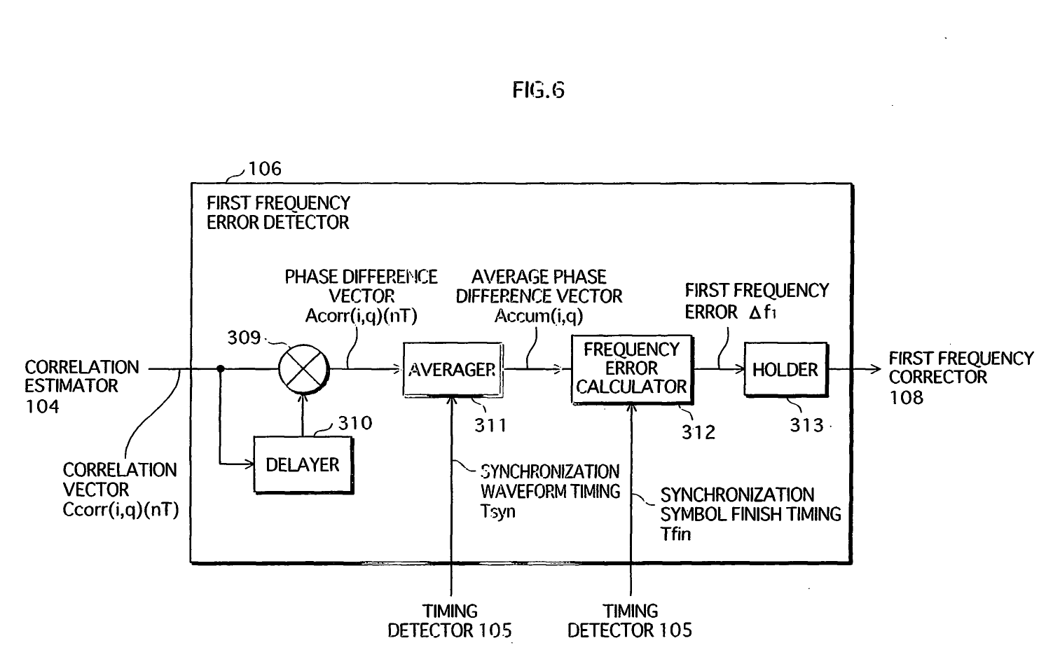

FIG. 6 is a functional block diagram showing the detailed structure of the first frequency error detector 106. The first frequency error detector 106 has a multiplier 309, a delayer 310, an averager 311, a frequency error calculator 312, and a holder 313.

The multiplier 309 finds a phase difference vector Acorr(i,q) (nT) that indicates a difference in phase between a correlation vector Ccorr(i,q)(nT) and a correlation vector (i,q)((n-D)T) delayed a predetermined sample count D by the delayer 309, by multiplying a complex conjugate of the phase vector Ccorr(i,q)(nT) and the delayed correlation vector Ccorr(i,q)((n-D)T) (FIG. 3(g)).

By using the sample count D as the sample count L of one cycle of the synchronization frequency in the reference signal, a phase difference vector can be obtained that indicates how much the phase error between the reception signal and the reference signal has changed between two synchronization waveforms.

The averager 311 finds an average phase difference vector Accum(i,q) by totaling the phase difference vectors (FIG. 3(h)). The frequency error calculator 312 calculates an average phase difference vector direction as a phase error average θ, and finds a first frequency error [symbol] f1 from the phase error average θ. These are calculated according to Equation 2 and Equation 3.

$$\begin{matrix}{Accum}_{( i , q )} = \sum {Acorr}_{( i , q )} & ( 2 ) \\ θ = {tan}^{- 1} \frac{{Accum}_{( q )}}{{Accum}_{( i )}} , Δ {f}_{1} = \frac{θ}{2 π T} & ( 3 )\end{matrix}$$

The averager 311 may find the average phase difference vector by totaling only the phase vectors obtained at the peak timing shown by the synchronization waveform timing signal Tsyn. This is because the correlation at the peak timing is greater than the correlation at other times, and therefore, in reality the phase vector at the peak timing affects the average value. Furthermore, a waveform having a long cycle may be used in order to increase resolution of the obtained phase error.

The frequency error calculator 312 outputs the first frequency error [symbol] f1 obtained with the timing indicated by the synchronization symbol finish timing signal Tfin to the holder 313, and the holder 313 holds the first frequency error [symbol] f1 supplied by the frequency error calculator 312. In this way, the frequency error obtained from the synchronization symbols is used in frequency correction of the subsequent data symbols.

<Absolute Phase Error Detector 107>

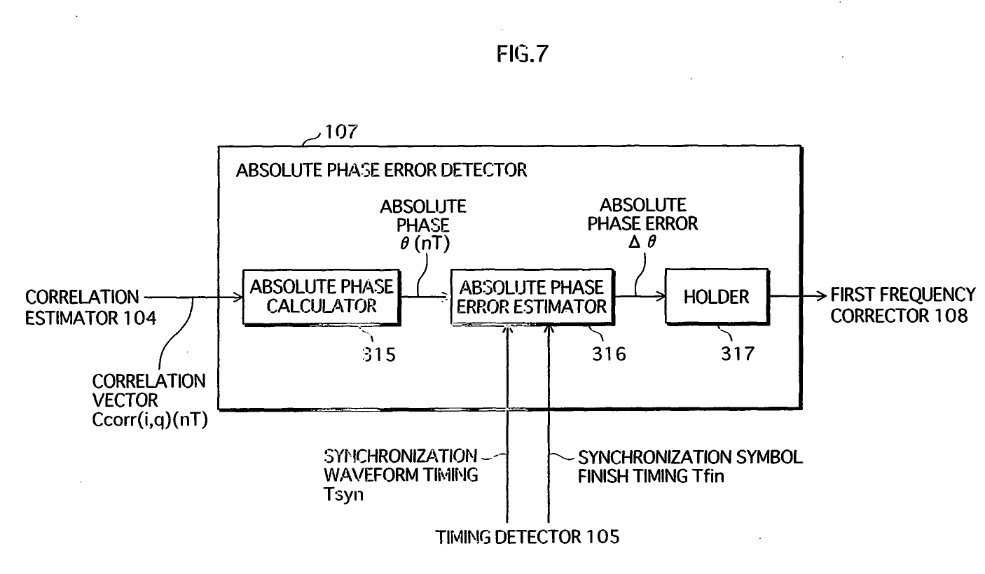

FIG. 7 is a functional block diagram showing the detailed structure of the absolute phase error detector 107. The absolute phase error detector 107 has an absolute phase calculator 315, an absolute phase error estimator 316, and a holder 317.

The absolute phase calculator 315 calculates a correlation vector Ccorr(i,q) (nT) direction as an absolute phase θ (nT) of the reception signal and the reference signal.

The absolute phase error estimator 316 holds a time of each peak timing indicated by the synchronization waveform timing signal Tsyn, in correspondence with the absolute phase, and estimates an absolute phase time transition based on the time and absolute phase held up to the time of estimation. Specifically, the absolute phase error estimator 316 may, for example, use a method of least squares to find an approximate straight line expressing the relationship between time and absolute phase. The absolute phase error estimator 316 then finds the absolute phase at the timing on the approximate straight line indicated by the synchronization symbol finish timing signal Tfin, as the absolute phase error [symbol] θ (FIG. 3(f)).

The holder 317 holds the absolute phase error [symbol] θ obtained by the absolute phase error estimator 316. In this way, the absolute phase error obtained from the synchronization symbols is used in absolute phase correction of the subsequent data symbols.

<First Frequency Corrector 108>

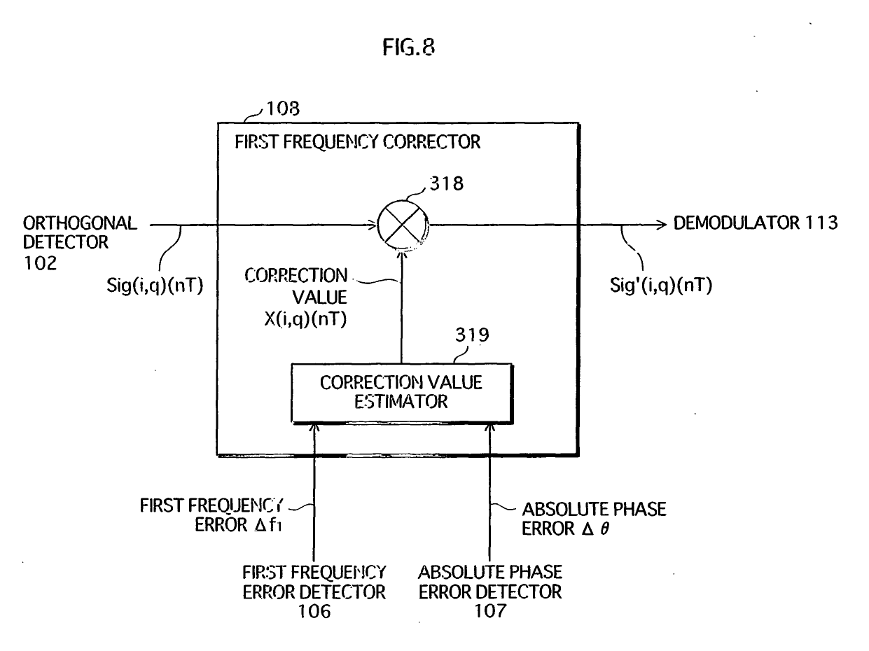

FIG. 8 is a functional block drawing showing the detailed structure of the first frequency corrector 108. The first frequency corrector 108 has a multiplier 318 and a correction value calculator 319.

The correction value calculator 319 generates a complex sine wave X(i,q)(nT) for giving a frequency shift and phase rotation that cancel the first frequency error [symbol] f1 and the absolute phase error [symbol] θ to the reception signal Sig(i,q) (nT).

The multiplier 318 simultaneously corrects the frequency and absolute phase of the reception signal by performing a complex multiplication of the reception signal and the complex sine wave, and outputs the corrected reception signal Sig′(i,q)(nT).

<Absolute Phase Error Transition>

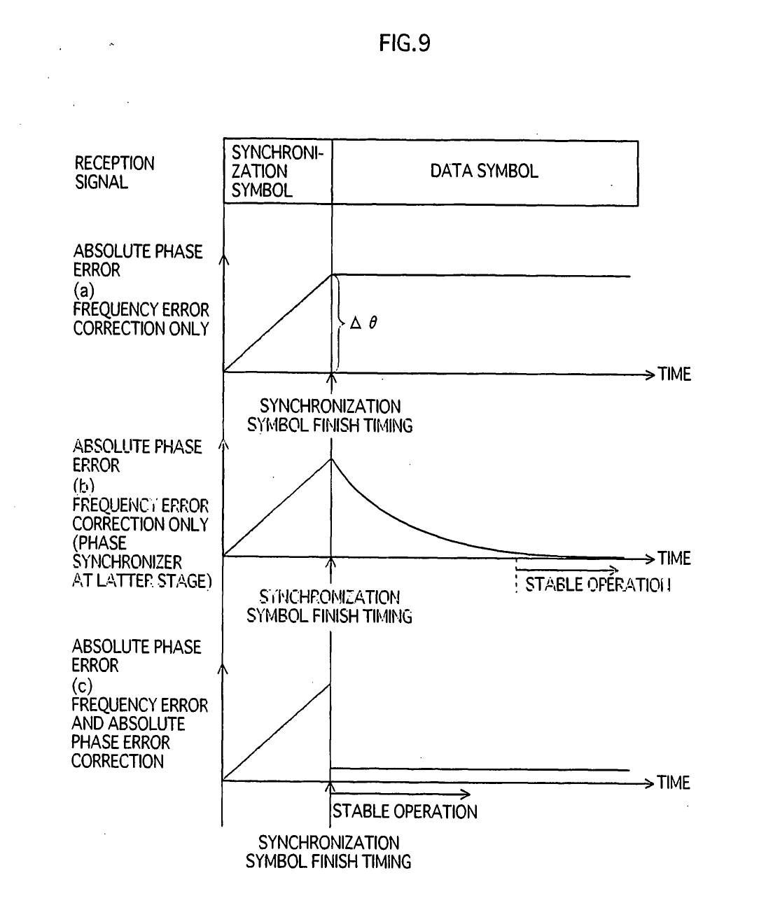

FIG. 9 is a graph showing chronological transition (convergence speed) of absolute phase error of each of a reception signal corrected by the conventional frequency synchronization apparatus and a reception signal corrected by the frequency synchronization apparatus of the first embodiment with the reference signal.

FIG. 9(a) shows transition of the absolute phase error of the signal obtained by the conventional technique of correcting the frequency error only. According to the conventional technique, only the frequency error is corrected in the synchronization symbol period, and therefore fluctuations in phase are not exhibited in the data symbol period, but the absolute phase error is fixed at an irregular position.

FIG. 9(b) shows transition of the absolute phase error of the signal obtained by a latter-stage synchronizer correcting the absolute phase difference of the signal in (a). Here, the greater the absolute phase error at the synchronization symbol finish point, the greater the amount of time required for the synchronizer to correct the absolute phase error and converge the absolute phase error into a stable operational range. The resulting loss in time leads to a deterioration of transmission efficiency. If the convergence time is excessively reduced in order to alleviate the deterioration of transmission efficiency, a different problem may arise that an apparatus at yet a latter stage will be unable to follow the resulting drastic fluctuations in phase. Consequently, there is a limit to how much the convergence time can be reduced.

FIG. 9(c) shows transition of the absolute phase error of a signal obtained according to the frequency synchronization apparatus of the first embodiment. Since the absolute phase of the subsequent data symbols is corrected according to the absolute phase error estimated in the synchronization symbol period, the absolute phase error is extremely low from the start of the data symbol period, and is kept approximately the estimated error value of the frequency and absolute phase.

### Summary of the First Embodiment

As has been described, according to the frequency synchronization apparatus of the first embodiment of the present invention, frequency error and absolute phase error of a signal are able to be simultaneously corrected using a predetermined symbol.

Since a single signal in which a signal waveform that exhibits a high autocorrelation property occurs at least twice is used as the predetermined symbol, loss in efficiency that occurs in transmission of the synchronization symbol can be reduced. Furthermore, since all processing relating to signal correction can be performed in time series, the frequency synchronization apparatus can be realized with a relatively simple structure, and is not limited to being applied to a specific transmission method such as OFDM.

Note that a frequency synchronization method that includes steps that correspond to the processing performed by the blocks of the first frequency synchronizer 103 is also included in the present invention.

### Second Embodiment

The frequency synchronization apparatus of the second embodiment differs from the frequency synchronization apparatus of the first embodiment in that it has added holders that hold the first frequency error [symbol] f1 and the absolute phase error θ, and it corrects the reception signal according to the first frequency error [symbol] f1 and the absolute phase error [symbol] θ held by the holders.

The following describes the frequency synchronization apparatus of the second embodiment with reference to the drawings. Note that structural elements that are the same as in the first embodiment have the same reference numbers thereas, and are omitted from the following description.

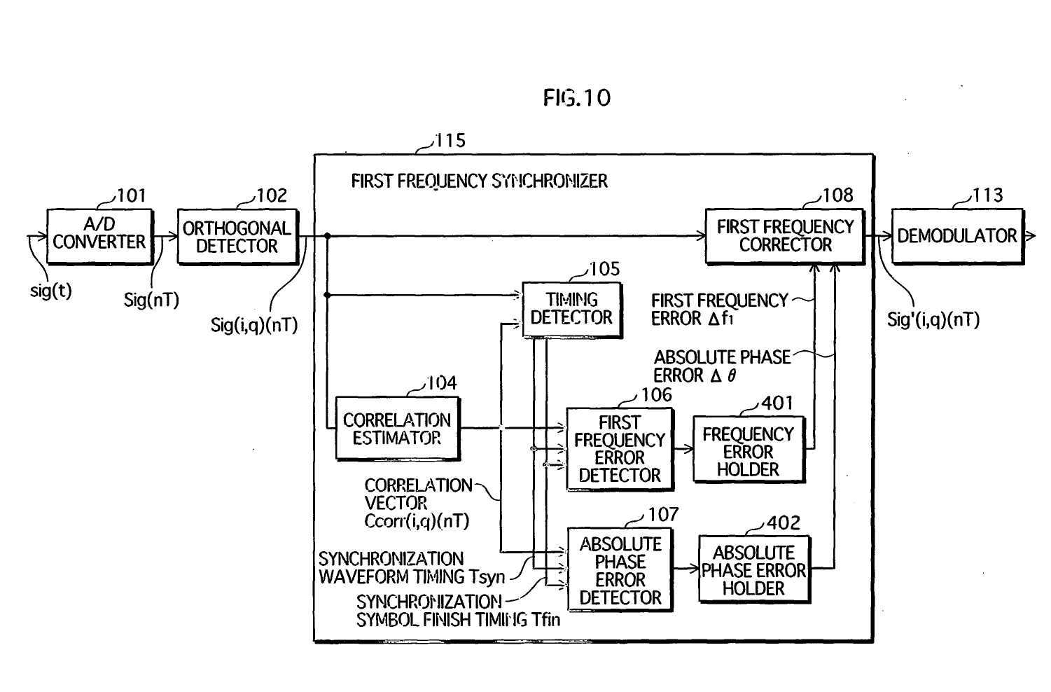

FIG. 10 is a functional block diagram showing the overall structure of the frequency synchronization apparatus of the second embodiment, together with part of the wireless reception apparatus that is the higher apparatus. In FIG. 10, a first frequency synchronizer 115 corresponds to the frequency synchronization apparatus of the second embodiment. In addition to the structure of the first frequency synchronizer 103 in the first embodiment (see FIG. 1), the first frequency synchronizer 115 has a frequency error holder 401 and an absolute phase error holder 402.

The frequency error holder 401 holds the first frequency error [symbol] f1 obtained by the first frequency error detector 106, and when a new frequency error is subsequently obtained, updates the held frequency error with the new frequency error if an absolute value of a difference between the held frequency error and the new frequency error is greater than a predetermined threshold value, and ignores the new frequency error and continues to hold the previous frequency error if the absolute value is not greater than the predetermined threshold value.

The absolute phase error holder 402 holds the absolute phase error [symbol] θ obtained by the absolute phase error detector 107, and when a new absolute phase error is obtained, updates the held absolute phase error with the new absolute phase error if an absolute value of a difference between the held absolute phase error and the new absolute phase error is greater than a predetermined threshold value, and ignores the new absolute phase error and continues to hold the previous absolute phase error if the absolute value is not greater than the predetermined threshold value.

The first frequency corrector 108 is modified so as to be supplied with the frequency error held by the frequency error holder 401 and the absolute phase error held by the absolute phase error holder 402. The first frequency corrector 108 corrects the reception signal by simultaneously giving the reception signal a frequency shift and phase rotation that cancel out the frequency error and the absolute phase error, as described in the first embodiment.

In the first frequency synchronizer 103, the correction amount of the reception signal is updated each synchronization symbol with a newly calculated frequency error and absolute phase error, but in the first frequency synchronizer 115, according to the stated structure, the correction value of the reception signal is only updated with the frequency error and the absolute phase error when the transmission path properties fluctuate to a relatively large extent.

### Summary of the Second Embodiment

As has been described, according to the frequency synchronization apparatus of the second embodiment of the present invention, the correction value is limited to being updated as few times as practical.

The present frequency synchronization apparatus is ideal for use in a two-stage structure in which the present frequency apparatus performs coarse synchronization and a synchronizer provided at a latter stage performs fine synchronization. Although a problem occurs in such a structure of a loss in efficiency for the latter-stage synchronizer to re-establish fine synchronization each time the present frequency synchronization apparatus updates the correction value, this loss is alleviated because the number of times that the present frequency synchronization apparatus updates the correction value is limited to as few as practical.

The present frequency synchronization apparatus is also ideal for processing transmission frames in which synchronization symbols are incorporated at predetermined intervals. In this case, while being given numerous opportunities to obtain an appropriate correction value, the present frequency synchronization apparatus updates the correction value as few times as possible, and therefore is able to both maintain a high degree of accuracy in synchronization and reduce the loss in fine synchronization.

Note that a frequency synchronization method that includes steps that correspond to the processing performed by the blocks in the first frequency synchronizer 115 is included in the present invention.

### Third Embodiment

The frequency synchronization apparatus of the third embodiment differs from the frequency synchronization apparatus of the second embodiment in that it additionally includes a second frequency synchronizer that performs frequency synchronization in compliance with a modulation method. The second frequency synchronizer corrects the frequency error of the reception signal by, for example, finding a time series of information symbols by demodulating the reception signal, and detecting an amount of shift of a symbol point either every one or plurality of symbols.

The following describes the frequency synchronization apparatus of the third embodiment with reference to the drawings. Note that structural elements that are the same as in the second embodiment have the same reference numbers thereas, and are omitted from the following description.

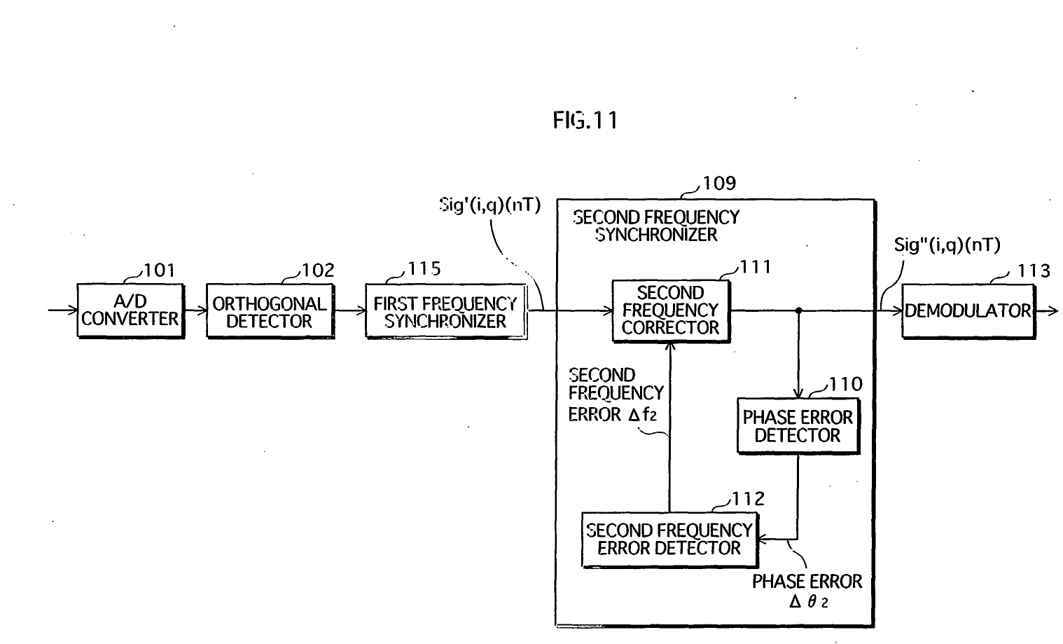

FIG. 11 is a functional block diagram showing the overall structure of the frequency synchronization apparatus of the third embodiment, together with part of the wireless reception apparatus that is the higher apparatus. In FIG. 11, the first frequency synchronizer 115 and a second frequency synchronizer 109 correspond to the frequency synchronization apparatus of the third embodiment.

The second frequency synchronizer 109 has a second frequency corrector 111, a phase error detector 110, and a second frequency error detector 112.

The second frequency corrector 111 gives the reception signal Sig′(i,q)(nT) corrected by the first frequency synchronizer 115 a frequency shift that cancels out a second frequency error [symbol] f2 notified by the second frequency error detector 112, and thereby obtains a further corrected reception signal Sig″(i,q) (nT) which it outputs to the demodulator 113.

The phase error detector 110 demodulates the corrected reception signal Sig″(i,q)(nT) into an information signal, and, for each one or plurality of information symbols, detects a phase error [symbol] θ2 between a symbol point expressed by the obtained information signal and a symbol point closest in the symbol points able to be obtained according to the modulation method.

The second frequency error detector 112 notifies the second frequency corrector 111 of the second frequency error [symbol] f2, which corresponds to the phase error [symbol] θ2.

<Absolute Phase Error Transition>

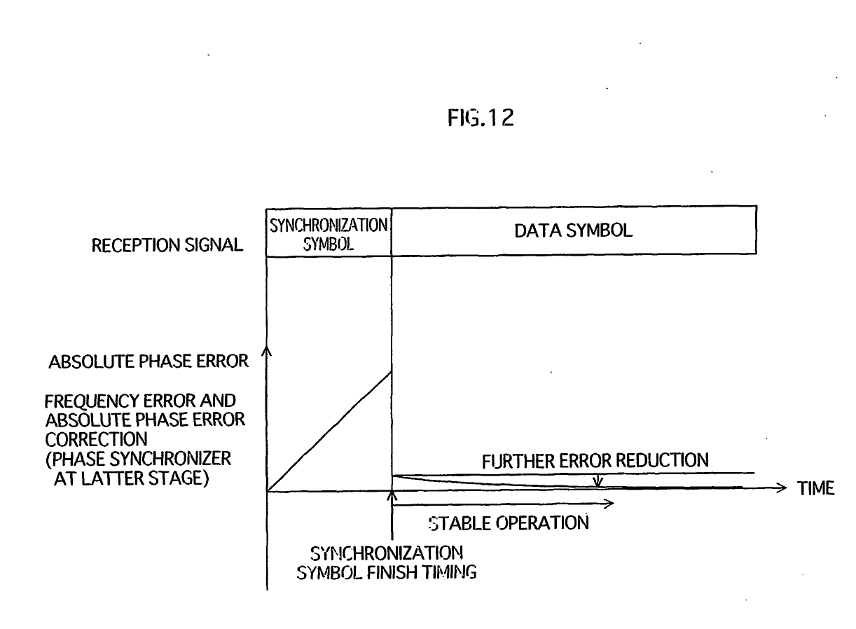

FIG. 12 is a graph showing chronological transition (convergence speed) of the absolute phase error between a signal obtained from the frequency synchronization apparatus of the third embodiment and the reference signal. Compared to FIG. 9(c), the absolute phase error is reduced even after the data symbol period starts due to the action of the second frequency synchronizer, and synchronization is realized with even greater accuracy.

Furthermore, since the absolute phase error is extremely low from the start of the data symbol period, if the absolute phase error was to deviate from the stable operational range at the start of the data symbol period, the amount of deviation would be minimal, and the time required to bring the phase error back into the stable operational rate would be extremely short compared to FIG. 9(b).

### Summary of the Third Embodiment

As has been described, according to the frequency synchronization apparatus of the third embodiment of the present invention, the first frequency synchronizer 115 finds the frequency error and the absolute phase error for each synchronization symbol, and corrects the reception signal to cancel out the frequency error and the absolute phase error. The second frequency synchronizer 109 finds the frequency error every information symbol or every plurality of information symbols using knowledge of the modulation method, and further corrects the corrected reception signal to cancel out the frequency error. Therefore, frequency fluctuations that occur in the data symbol period according to variations in transmission properties are corrected finely, and highly reliable communication is achieved.

Note that the described effects may be obtained by a structure obtained from a combination of the first frequency synchronizer 103 described in the first embodiment and the second frequency synchronizer 109 described in the second embodiment. Such a structure is also included in the present invention.

Furthermore, a frequency synchronization method that includes steps that correspond to the processing performed by the blocks of the first frequency synchronizer 115 and the second frequency synchronizer 109, and a frequency synchronization method that includes steps that correspond to the processing performed by the blocks of the first frequency synchronizer 103 and the second frequency synchronizer 109 are included in the present invention.

### Second Frequency Synchronizer Modification Example

One example of a modification of the second frequency synchronizer is a structure by which frequency synchronization is adapted to a multicarrier modulation method.

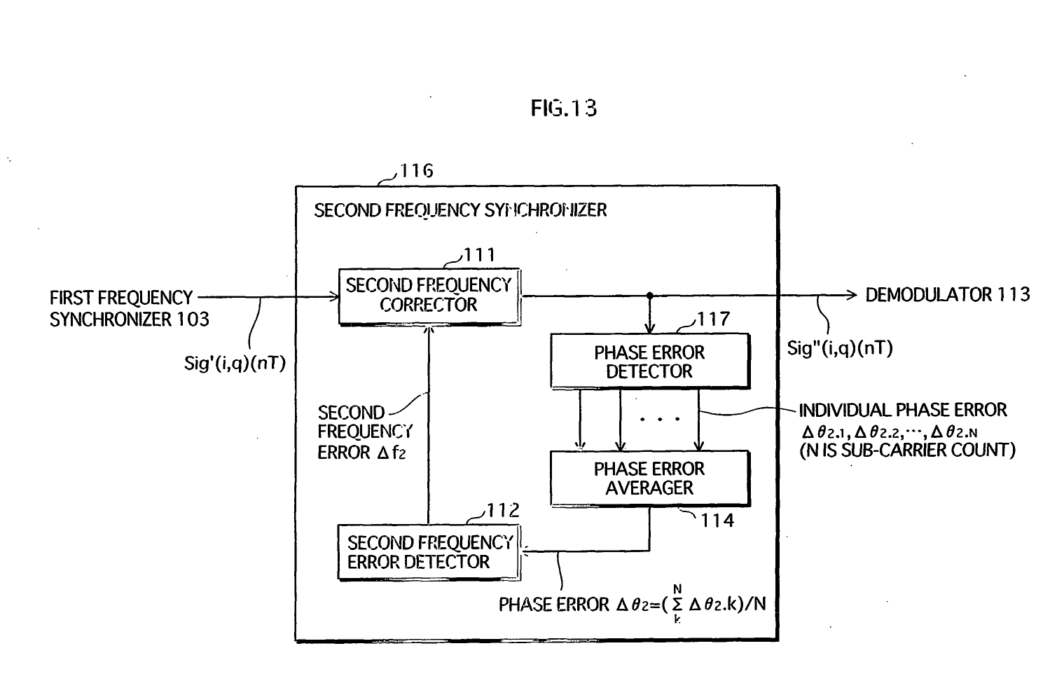

FIG. 13 is a functional block diagram showing the detailed structure of the second frequency synchronizer 116 of the modification example. Here, reception signals Sig′(i,q)(nT) and Sig″(i,q)(nT) are signals that have been modulated by a multicarrier modulation method. The second frequency synchronizer 116 differs from the second frequency synchronizer 109 in that it has a phase error detector 117 and a phase error averager 114 that conform to the multicarrier modulation method, instead of the phase error detector 110.

The phase error detector 117 demodulates each sub-carrier of the reception signal Sig″(i,q)(nT) that has corrected by the second frequency corrector 111 into information signals, and detects, for each sub-carrier, phase error [symbol] θ2.1, [symbol] θ2.2, through to [symbol] θ2. N between a symbol point expressed by the obtained information signal and closet symbol point able to be obtained according to the modulation method in the particular sub-carrier. Note that N is the sub-carrier count.

The phase error averager 114 finds an average phase error across all sub-carriers.

The second frequency error detector 112 and the second frequency corrector 111 correct the frequency error of the reception signal Sig′(i,q) (nT) according to the average phase error, thereby obtaining the reception signal Sig″(i,q) (nT).

With this structure, if, for example, tone noise is present on a specific sub-carrier, the effect of the noise is dispersed across all the sub-carriers by averaging the absolute phase error of the sub-carriers, and therefore the danger that the frequency of the specific sub-carrier will be mistakenly corrected due to the effect of the noise is reduced. In particular, if the specific sub-carrier is one that is modulated according to a CDMA (code division multiple access) method, since the tone noise is spread due to demodulation, the possibility of obtaining correct data is high if mistaken correction is avoided.

### Fourth Embodiment

Here, a synchronization symbol generation method used in the frequency synchronization apparatuses and frequency synchronization methods of the first to third embodiments is described.

It is necessary for the synchronization waveform that composes the synchronization symbol to have both a strong autocorrelation property and a spectrum that falls within a desired frequency band. This is because the synchronization waveform can be more accurately detected if a signal that has a strong autocorrelation property is used as the synchronization waveform. Furthermore, the spectrum must fall within the frequency band being used, in order to avoid affecting neighboring channels.

The following describes a generation method that generates an ideal synchronization symbol by execution of a selection step of selecting a numeric sequence that exhibits a strong autocorrelation property, a synchronization waveform generation step of generating a synchronization waveform from the selected numeric sequence, and a synchronization symbol generation step of generating a synchronization symbol so as to include the generated synchronization waveform at least twice.

<Selection Step>

In the selection step, a numeric sequence that expresses a digital signal and that has a strong autocorrelation property is selected.

An example of such a numeric sequence is a PN code. PN codes are known to have strong autocorrelation properties, the Barker code being one of these. The Barker code is a type of PN code that has a limited number of taps. There are several types of Barker codes that vary in terms of length of tap, but any of these codes may be used. The fact must be taken into account that the accuracy with which frequency error can be detected can be increased if a long Barker code is used for the synchronization waveform, but that transmission efficiency is reduced if the synchronization symbol is long.

<Synchronization Waveform Generation Step>

If the synchronization waveform is expressed using the selected PN code unchanged, the spectrum of the synchronization waveform will spread over the frequency of the whole signal band. If a signal that deviates from the spectrum of the main signal is used as the synchronization symbol, interference will be caused with the spectrum overlapping with the neighboring main signal. Consequently, the signal used as the synchronization waveform must have a narrow pass frequency band and desired frequency properties.

For this reason, in the synchronization generation step, the synchronization waveform is generated by eliminating high frequency components outside the desired band from a digital signal expressed by the numeric sequence whose sampling frequency is treated so as to be half or less of the desired band width. Here, the object is to obtain a synchronization waveform whose frequency spectrum main lobe falls within the desired band, and from which a side lobe, which is the frequency loop-back component outside the desired band, is eliminated.

As one example of a specific method for obtaining a signal waveform such that the main lobe of the frequency spectrum falls within the desired band, each one chip of the PN sequence may be repeated one or more times to create a new sequence. By repeating each chip in this way, the original PN sequence expresses a signal that is drawn out along a time axis.

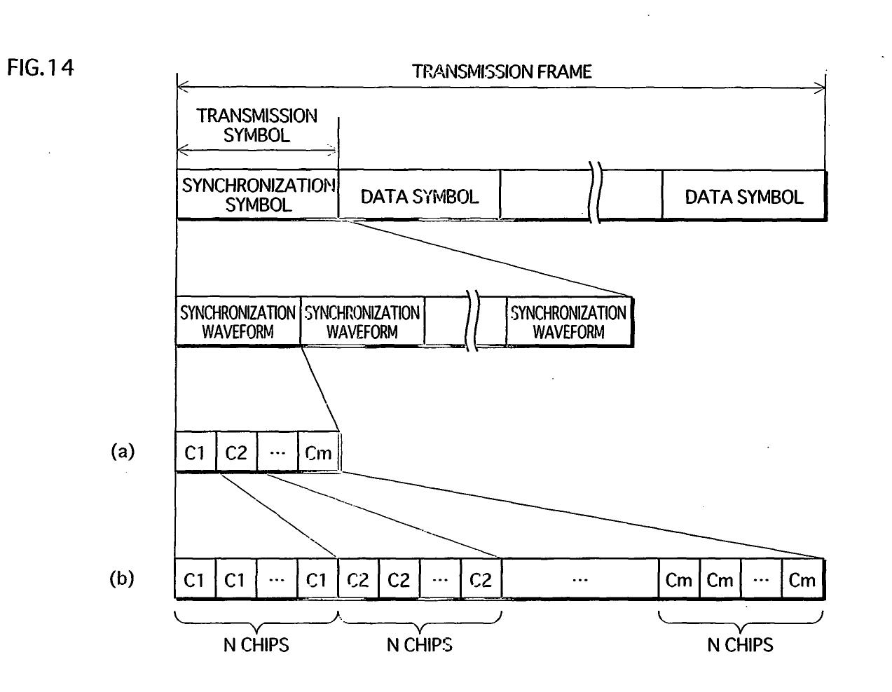

FIG. 14 shows the configuration of a synchronization symbol in which each chip in a PN sequence has been repeated. FIG. 14 shows that one frame is composed of a synchronization symbol and a plurality of data symbols, that the synchronization symbol is composed of a plurality of waveforms, and that the waveform is composed of (a) or (b). In FIG. 14, (a) expresses a case in which a PN sequence having a tap count m is used as the synchronization waveform, and (b) expresses a case in which each chip occurs N times.

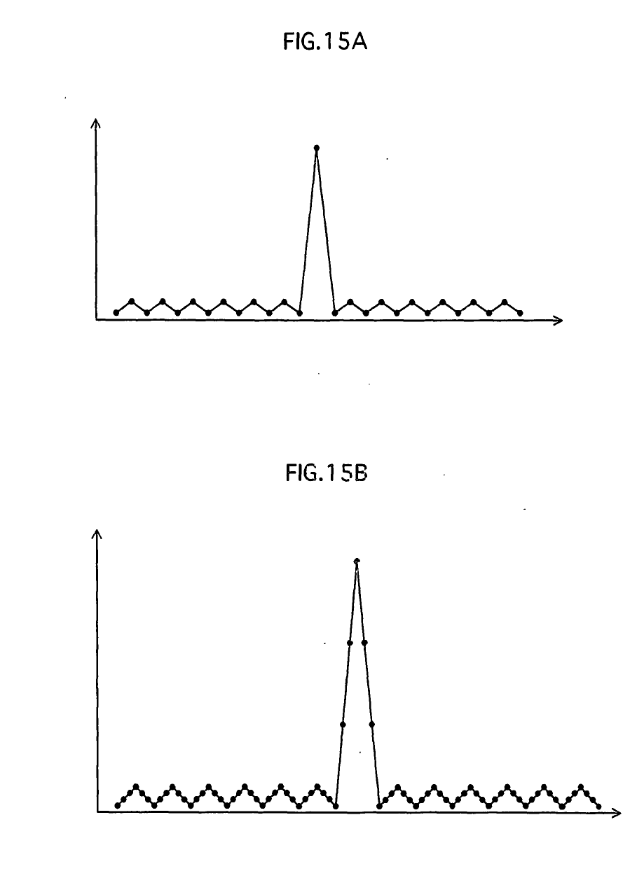

Furthermore, in FIG. 15, (a) and (b) show respective autocorrelation properties of when (a) and (b) in FIG. 14 are used as the synchronization waveform. FIG. 15 shows that in both (a) and (b) an autocorrelation peak occurs at a point where the signals overlap, and that the autocorrelation property is strong. Note that (b) in FIG. 15 shows that the peak occurs across several samples, because each chip is repeated several times. However, the maximum value occurs at one point in this case also. Here, lengthened time on the time axis means that a narrowed frequency band on the frequency axis. Therefore, the width of the spectrum of a signal that is composed of a plurality of each chip can be decreased by increasing the number of repeats. By repeating each chip of the PN sequence in this way, the width of the spectrum can be set to be narrow.

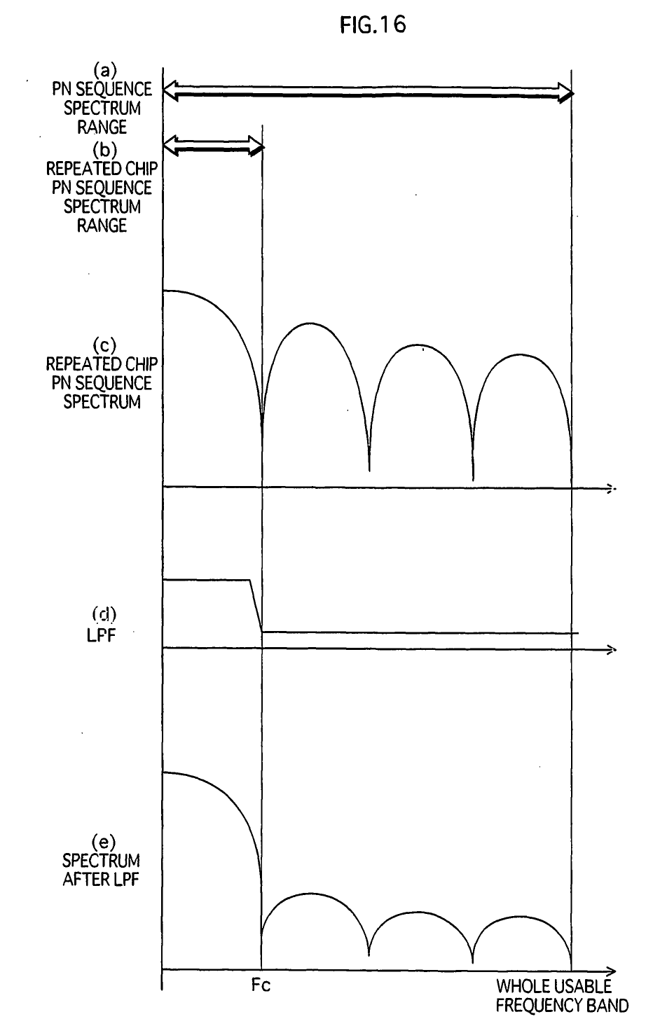

FIGS. 16 (a) to (c) are schematic diagrams showing how the spectrum changes by repeating each chip. FIG. 16(a) shows the range of the spectrum when the PN sequence is used without change as the synchronization waveform, and shows that the spectrum spreads across the whole useable frequency band. Furthermore, FIG. 16(b) shows the range of the spectrum when a signal in which each chip of the PN sequence is repeated is used as the synchronization waveform. The range of the spectrum is smaller than that of FIG. 16(a). FIG. 16(c) shows a specific example of the spectrum. This drawing shows that the main lobe of the spectrum falls with in the desired frequency band. By increasing the number of repeats of each chip, the frequency range of the main lobe is reduced.

Furthermore, the width of the frequency band used in reduced when a waveform in which each chip of the PN sequence is repeated a plurality of times as described above is used, but the side lobes remain large compared with other noise and the like (FIG. 16(c)). This may reduce overall precision because interference with other channels increases, and may cause increased residual frequency error. Residual frequency error denotes frequency estimation error that occurs when noise is not included.

For this reason, an LPF (low pass filter) may be designed to obtain a synchronization waveform from which side lobes have been eliminated, and frequency properties further improved by reducing the signal levels outside the desired frequency band. Here, the LPF may be designed using a common method such as cosine roll off. In this way, by using a signal that has passed through the LPF as the synchronization waveform, a synchronization waveform that has the desired frequency properties can be obtained.

FIGS. 16(d) and (e) show how the spectrum of the synchronization waveform changes according to the described processing. FIG. 16(d) shoves frequency properties of an LPF having a cutoff frequency Fc. The spectrum of the signal that is obtained by repeating each PN signal shown in FIG. 16(c) becomes as shown in FIG. 16(e) by passing through the LPF. A synchronization waveform that does not affect neighboring channels can be obtained by cutting band parts higher than this cutoff frequency Fc.

<Synchronization Symbol Generation Step>

In the synchronization generation step, the synchronization symbol is generated by including the synchronization waveform obtained in the aforementioned step at least twice.

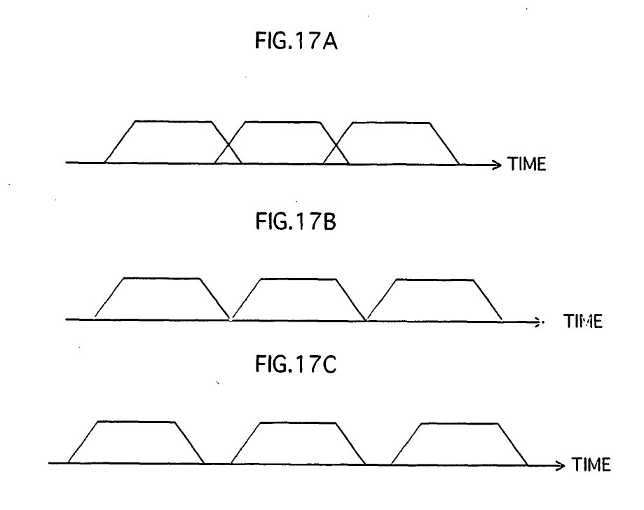

In the above, fluctuations at the start and end of the synchronization waveform remain after passing through the LPF as an extension of the LPF. For this reason, when repeating the synchronization waveform that has passed through the LPF, the fluctuations of the subsequent and previous synchronization waveforms of a particular synchronization waveform will overlap with the particular waveform (FIG. 17(a)), possibly causing deterioration in frequency error detection precision. To solve this problem, the beginning and end of each synchronization waveform may be null, thereby reducing the described effect in the repetition. This is shown in FIGS. 17(b) and (c). As shown in FIG. 17(b), the synchronization waveform may be repeated so that synchronization waveforms neighbor each other exactly but do not overlap, or, as shown in FIG. 17(c), repeated completely removed from each other.

<Additional Remarks>

The synchronization symbol generator 302 in the correlator 301 generates a reference signal expressing a waveform that is identical to the synchronization waveform generated in this way. Here, the synchronization symbol generator 302 may generate the reference signal with the same quantized bit count as the synchronization waveform in the reception signal, or may generate the reference signal with a lower quantized bit count as the synchronization waveform (for example, approximated with an integer). Even with such an approximation, there will be no effect on the frequency estimation accuracy because the frequency synchronizer and the frequency synchronization method of the present invention focus on the magnitude (peak) of the correlation, not the value of the correlation. Such an approximation enables the actual scale of the circuit to be reduced.

<Application of the Signal Transmission Method>

A synchronization symbol obtained by generating a synchronization waveform and repeating the synchronization waveform according to the described method enables frequency synchronization to be performed without interference with neighboring channels.

Furthermore, by combining the described synchronization symbol generation method and the frequency synchronization method described in any one of the first to third embodiments, a signal transmission method having the characteristics of both methods can be obtained. Such signal transmission method is also included in the present invention.

### INDUSTRIAL APPLICABILITY

The frequency synchronization apparatus and frequency synchronization method of the present invention can be used for equalization of signals received by wireless or wired communication, in, for example, a wireless reception apparatus, a digital television broadcast receiver, a digital CATV receiver, a wireless LAN adapter, or a mobile information terminal that has a communication or broadcast reception function.

frequency shift and a phase rotation that cancel out the frequency error recorded in the frequency error holding step and the absolute phase error recorded in the absolute phase error recording step.

12. The frequency synchronization method of claim 10, further comprising:
a second frequency correction step of being instructed of a frequency shift, and giving a signal obtained in the first frequency correction step the instructed frequency shift;
a phase error detection step of demodulating a signal obtained in the second frequency correction step and successively finding symbol points in the demodulated output signal, and detecting a phase error between the found symbol points and symbol points able to be found in a modulation method of the output signal; and
a second frequency error detection step of successively instructing to the second frequency correction step of a frequency shift that cancels out the detected phase error.

13. The frequency synchronization method of claim 12, further comprising:
a frequency error recording step of recording the found frequency error, and, when a new frequency error is subsequently the found symbol points and symbol points able to be obtained in a modulation method of the sub-carrier,
the frequency synchronization method further comprises:
a phase error averaging step of averaging phase errors detected simultaneously for all or some of the sub-carriers in the absolute phase error detection step, and
the second frequency detection step successively instructs the second frequency correction step of a frequency shift that cancels out the average phase error.

15. (canceled)

16. (canceled)

17. (canceled)

18. (canceled)

19. (canceled)

20. (canceled)

21. A frequency demodulation method that corrects an input signal from an external source, based on a correlation between the input signal and a reference signal, and demodulates the corrected input signal, the input signal including a synchronization symbol that is composed of a synchronization waveform that exhibits a predetermined autocorrelation property and is included at least twice in the synchronization symbol, and the reference signal expressing a waveform that is identical to the synchronization waveform, the frequency demodulation method comprising:
a frequency synchronization step of finding a frequency error between the input signal and the reference signal, based on an average phase difference between each pair of chronologically neighboring correlation vectors found cyclically between the input signal an the reference signal, finding an absolute phase error between the input signal and the reference signal, based on chronological transition of absolute phase of the correlation vectors, and correcting the input signal based on the found frequency error and the found absolute phase error; and
a demodulation step of demodulating the corrected input signal, thereby generating a demodulated signal.

22. The demodulation method of claim 21,
wherein the frequency synchronization step further includes:
a correlation sub-step of successively finding correlation vectors between the input signal and the reference signal;
a timing detection sub-step of identifying, based on chronological transition in magnitude of the obtained correlation vectors, each cycle of the synchronization waveform;
a first frequency error detection sub-step of finding a frequency error between the input signal and the reference signal, based on an average phase difference between each pair of chronologically neighboring correlation vectors that are representative of the identified cycles;
an absolute phase error detection sub-step of finding an absolute phase error between the input signal and the reference signal, based on chronological transition of absolute phase of correlation vectors that are representative of the identified cycles; and
a first frequency correction sub-step of correcting the input signal by simultaneously giving the input signal a frequency shift and a phase rotation that cancel out the found frequency error and the found absolute phase error.

23. The frequency synchronization method of claim 22,
wherein the synchronization step further includes:
a second frequency correction sub-step of being instructed of a frequency shift, and giving a signal obtained in the first frequency correction step the instructed frequency shift;
a phase error detection sub-step of demodulating a signal obtained in the second frequency correction step and successively finding symbol points in the demodulated output signal, and detecting a phase error between the found symbol points and symbol points able to be found in a modulation method of the output signal; and
a second frequency error detection sub-step of successively instructing to the second frequency correction step of a frequency shift that cancels out the detected phase error.
